(19) United States
(12) Patent Application Publication
(10) Pub. No.: US 2025/0356194 A1
(43) Pub. Date: Nov. 20, 2025

(54) GENETIC ALGORITHM-BASED ADAPTIVE BATCH SELECTION FOR HESSIAN QUANTIZATION IN NEURAL NETWORKS

(71) Applicants: A. A. Kavindu Ravishka Adhikari, Gampaha (LK); D. M. R. S. Vinodh Gunasekera, Houston, TX (US); Yasantha Rajakarunanayake, SAN RAMON, CA (US); Avishka Ranweera, KANDY (LK); Charitha Gunasekara, RAGAMA (LK); Isuru Kalahara, Talawatugoda (LK); Peter Suaris, Santa Clarita, CA (US)

(72) Inventors: A. A. Kavindu Ravishka Adhikari, Gampaha (LK); D. M. R. S. Vinodh Gunasekera, Houston, TX (US); Yasantha Rajakarunanayake, SAN RAMON, CA (US); Avishka Ranweera, KANDY (LK); Charitha Gunasekara, RAGAMA (LK); Isuru Kalahara, Talawatugoda (LK); Peter Suaris, Santa Clarita, CA (US)

(21) Appl. No.: 18/885,742

(22) Filed: Sep. 16, 2024

Related U.S. Application Data
(60) Provisional application No. 63/649,463, filed on May 20, 2024.

(51) Int. Cl. G06N 3/086; G06N 3/0495

(52) U.S. Cl. CPC G06N 3/086; G06N 3/0495

(57) ABSTRACT

In aspect, a computerized method of a genetic algorithm-based adaptive batch selection for hessian quantization in neural networks comprising: with at least one computer processer, computing a Hessian Matrix; performing an Eigenvalue Analysis on the Hessian matrix to generate a Hessian matrix eigenvalue that provides information about the curvature of the loss surface; determining a quantization level based on the Hessian matrix eigenvalue; using the quantization Level to set an appropriate quantization level for a layer weights of a neural network; and applying the quantization level to the layer weights of the neural network. This involves mapping the continuous floating-point values of the weights to discrete levels based on the determined quantization intervals.

### CLAIM OF PRIORITY

This patent application claims priority to U.S. Provisional Patent Application No. 63/649,463, filed on May 20, 2024, and titled GENETIC ALGORITHM-BASED ADAPTIVE BATCH SELECTION FOR HESSIAN QUANTIZATION IN NEURAL NETWORKS. This provisional patent application is hereby claimed by reference in its entirety.

### BACKGROUND

Optimizing neural networks through Hessian quantization is a pivotal strategy for enhancing their efficiency and performance. This process involves reducing the precision of numerical values in layer weights, typically to integers or fixed-point representations, based on the curvature insights from the Hessian matrix. However, achieving optimal Hessian quantization requires more than just applying uni-form batch selection across all layers. Each layer in a neural network exhibits varying data dependencies and sensitivities to quantization, making it essential to tailor batch selection strategies accordingly.

Furthermore, it is noted that prevailing method employs a uniform batch selection strategy for Hessian quantization across all layers within a model. This technique selects one data batch and applies it uniformly across all layers, irrespective of their unique characteristics and requirements. Uniform batch selection thus treats all layers equally and applies a consistent quantization process throughout the model's optimization. The process of uniform batch selection begins with dividing the dataset into batches of equal size. Each batch is then independently used for Hessian quantization across all layers, adhering to the same quantization procedure. This straightforward approach is relatively easy to implement, making it suitable for initial experimentation, bench-marking, and establishing a baseline for comparison. However, its simplicity may not fully exploit the optimization potential of neural networks.

One of the primary limitations of uniform batch selection is its inability to account for the distinct sensitivities to quantization exhibited by different layers. Neural network layers often have varying levels of sensitivity to quantization, implying that a one size-fits-all approach may lead to sub-optimal results. Tailored batch selection strategies, based on the specific requirements and sensitivities of each layer, have the potential to significantly enhance model efficiency and performance. While the prevailing approach serves as a foundational method for Hessian quantization, it falls short of achieving optimal performance across all layers. Neglecting the individual characteristics and data dependencies of each layer may limit the effectiveness of the overall optimization process. Consequently, there is a pressing need for alternative strategies that can adapt dynamically to the unique requirements of individual layers within the neural network, thereby unlocking the full potential of Hessian quantization for enhanced model efficiency and optimization.

### BRIEF SUMMARY OF THE INVENTION

In one aspect, a computerized method of a genetic algorithm-based adaptive batch selection for hessian quantization in neural networks comprising: with at least one computer processer, computing a Hessian Matrix; performing an Eigenvalue Analysis on the Hessian matrix to generate a Hessian matrix eigenvalue that provides information about the curvature of the loss surface; determining a quantization level based on the Hessian matrix eigenvalue; using the quantization Level to set an appropriate quantization level for a layer weights of a neural network; and applying the quantization level to the layer weights of the neural network. This involves mapping the continuous floating-point values of the weights to discrete levels based on the determined quantization intervals.

### BRIEF DESCRIPTION OF THE DRAWINGS

FIG. 1 illustrates an example process for batch selection for Hessian quantization in neural networks, according to some embodiments.

FIG. 2 illustrates an example Fitness Evaluation and Selection Process in Genetic Algorithms, according to some embodiments.

FIG. 3 illustrates an example process 300 with non-uniform batch selection with genetic algorithm, according to some embodiments.

FIG. 4 illustrates another example process 400, according to some embodiments.

FIG. 5 illustrates an example process for implementing a genetic algorithm-based adaptive batch selection for Hessian Quantization in neural networks, according to some embodiments.

FIG. 6 illustrates an example for optimizing neural network layers, according to some embodiments.

FIG. 7 an example process for generating initial candidates, according to some embodiments.

FIG. 8 an example process for implementing a crossover of the selected candidates, according to some embodiments.

FIG. 9 illustrates an example process for optimizing neural network layers, according to some embodiments.

The Figures described above are a representative set and are not an exhaustive with respect to embodying the invention.

### DESCRIPTION

Disclosed are a system, method, and article of production for genetic algorithm-based adaptive batch selection for Hessian quantization in neural networks. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Genetic algorithm (GA) is a metaheuristic inspired by the process of natural selection that belongs to the larger class of evolutionary algorithms (EA). Genetic algorithms are commonly used to generate high-quality solutions to optimization and search problems by relying on biologically inspired operators such as mutation, crossover and selection.

Hessian matrix can be a square matrix of second-order partial derivatives of a scalar-valued function, or scalar field. The Hessian matrix is a square matrix of second-order partial derivatives of a scalar-valued function. In the context of neural networks, this function is usually the loss function, which measures the difference between the predicted output and the actual output. The elements of the Hessian matrix thus express how the loss changes as each pair of model parameters (weights) is varied.

Neural network (i.e. an artificial neural network) is a model inspired by the structure and function of biological neural networks found in the brain. It consists of connected units or nodes called artificial neurons. These are linked by edges, which model the synapses in a biological brain. Each artificial neuron receives signals from its connected neurons, then processes these inputs using a nonlinear function known as the activation function, and outputs a signal, typically represented as a real number, to other connected neurons. The strength and influence of the connections, represented by weights, are adjustable and are refined during the network's learning process to optimize performance.

### Example Systems and Methods

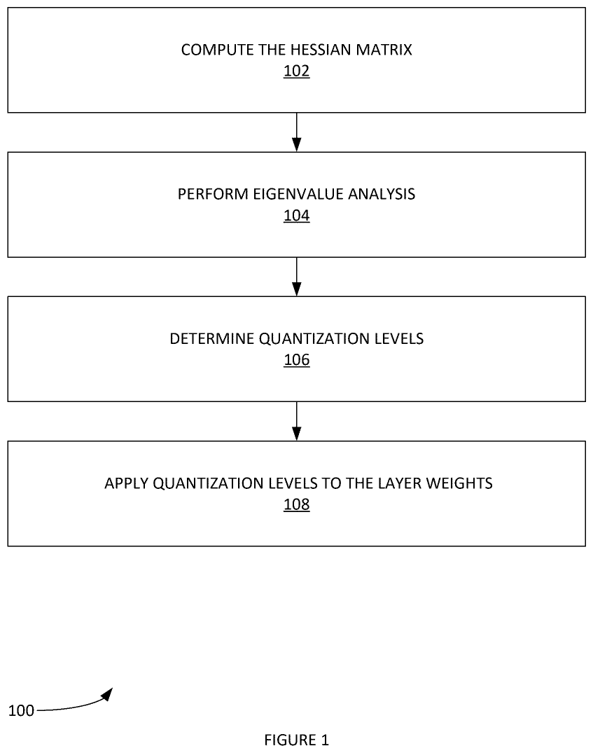

FIG. 1 illustrates an example process 100 for Hessian Quantization, according to some embodiments. It is noted that the Hessian matrix is a square matrix of second-order partial derivatives of a scalar-valued function, typically the loss function, with respect to the parameters of the model. In the context of neural networks, it provides information about the curvature of the loss surface with respect to the model parameters.

In step 102, process 100 can compute the Hessian Matrix. Computing or approximating the Hessian matrix typically involves calculating second-order partial derivatives of the loss function with respect to each parameter. The Hessian matrix can be computed analytically or approximated numerically.

In step 104, process 100 can perform Eigenvalue Analysis. Eigenvalue analysis on the Hessian matrix provides information about the curvature of the loss surface. Higher eigenvalues indicate regions of high curvature, while lower eigenvalues indicate regions of low curvature.

In step 106, process 100 can determine Quantization Levels. Quantization levels are determined based on Hessian matrix eigenvalues to determine the appropriate quantization levels for the layer weights. Regions of high curvature may require finer quantization levels to preserve model accuracy, while regions of low curvature may allow for coarser quantization.

In step 108, process 100 can apply quantization levels to the layer weights. This involves mapping the continuous floating-point values of the weights to discrete levels based on the determined quantization intervals.

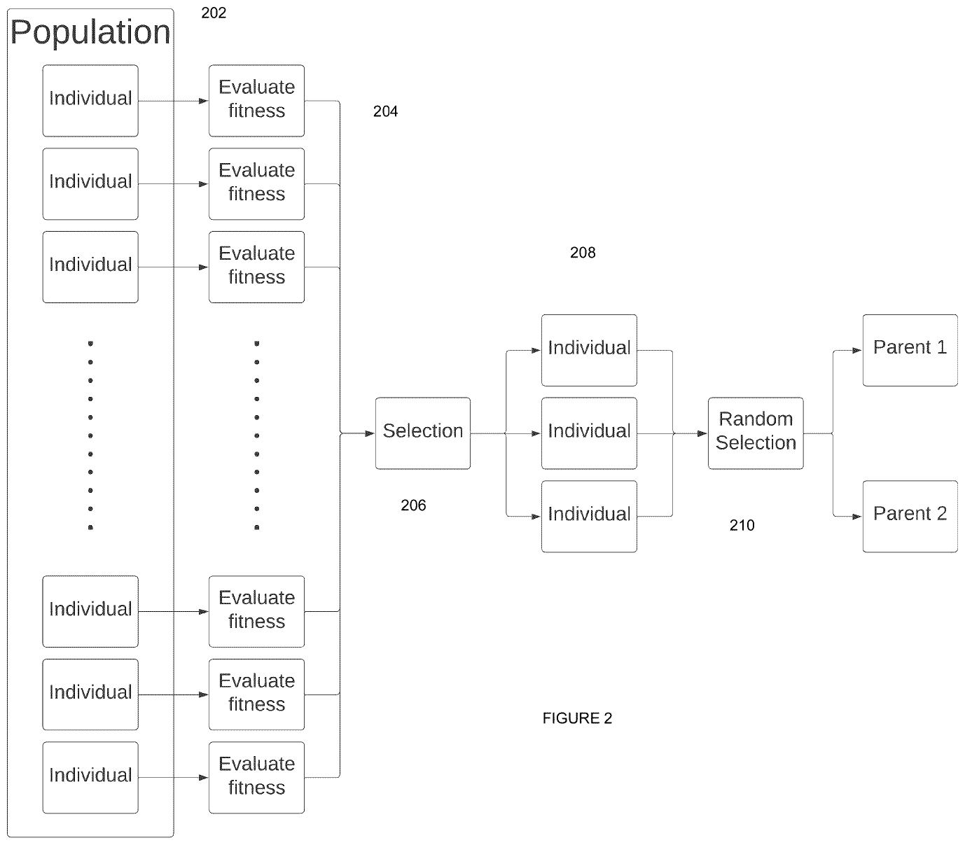

FIG. 2 illustrates an example Fitness Evaluation and Selection Process 200 in Genetic Algorithms, according to some embodiments. Block 202 shows the population of all individuals to be evaluated by Fitness Evaluation and Selection Process 200. Block 204 shows evaluation of the fitness of each individual in the population. Block 206 shows that the best individuals are selected. Block 208 shows the selected individuals. Block 210 shows that two individuals are selected from those selected in block 208. Block 212 shows that the candidates selected in 210 are used as the parents for the creation of the next individual.

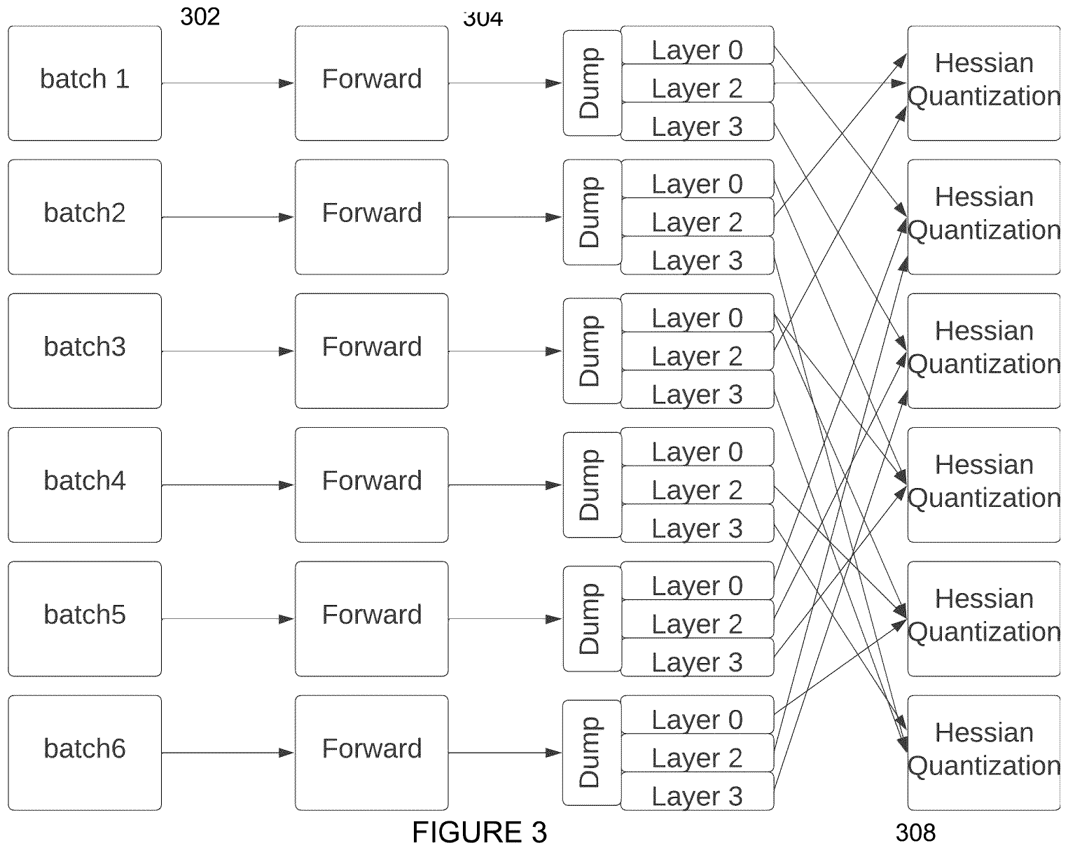

FIG. 3 illustrates an example process 300 with non-uniform batch selection with genetic algorithm, according to some embodiments. Block 302 shows the input data batches. Block 304 shows the forward the data batches through the model. Block 306 shows the input data dumps of each Neural Network (NN) layer of the model for each data batch. Block 308 illustrates an quantization of the model weights of each trainable layer using the Hessian quantization algorithm with the dumps.

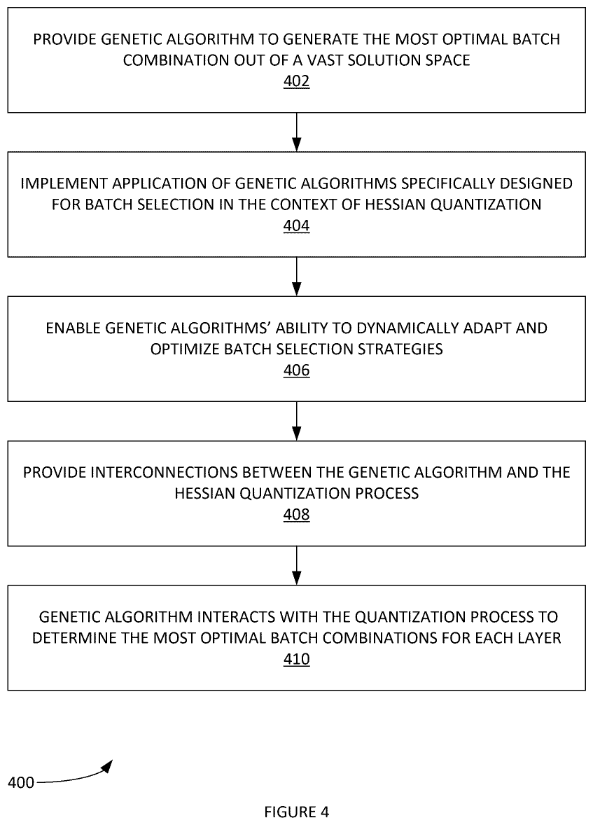

FIG. 4 illustrates another example process 400, according to some embodiments. Process 300 can be used to implement process 400 in some examples. Processes 300 and 400 provide improvements neural network optimization and genetic algorithms. In the realm of optimizing neural networks, existing methods commonly rely on uniform batch selection for Hessian quantization. However, such an approach often leads to sub-optimal performance as it overlooks the unique characteristics and data dependencies of individual layers within the network.

In step 402, process 400 uses a genetic algorithm to generate the most optimal batch combination out of a vast solution space. In step 404, process 400 implements the application of genetic algorithms specifically designed for batch selection in the context of Hessian quantization. This steps implements the optimization of batch selection based on the requirements of each layer, thereby enhancing the overall efficiency and effectiveness of Hessian quantization techniques.

In step 406, process 400 enables the genetic algorithms' ability to dynamically adapt and optimize batch selection strategies. By considering the varying data dependencies and sensitivities to quantization levels across different layers, the genetic algorithm optimizes the selection of batches to ensure an efficient Hessian quantization process. In step 408, process 400 provides interconnections between the genetic algorithm and the Hessian quantization process. The genetic algorithm interacts with the quantization process to determine the most optimal batch combinations for each layer in step 410.

One notable aspect of processes 100-400 (as well as processes 500 and 900 infra) are their flexibility and adaptability, leading to potential variations or alternative solutions. These variations may include adjusting genetic algorithm parameters or exploring alternative Hessian quantization methods, underscoring the approach's versatility and ability to capacity for innovation. Ultimately, processes 100-500 and 900 offer significant advantages over traditional uniform batch selection methods. By adapting itself to individual layer characteristics and requirements, it leads to improved model efficiency and optimization in neural network operations, making it a substantial advancement to the field of neural network optimization and genetic algorithm applications.

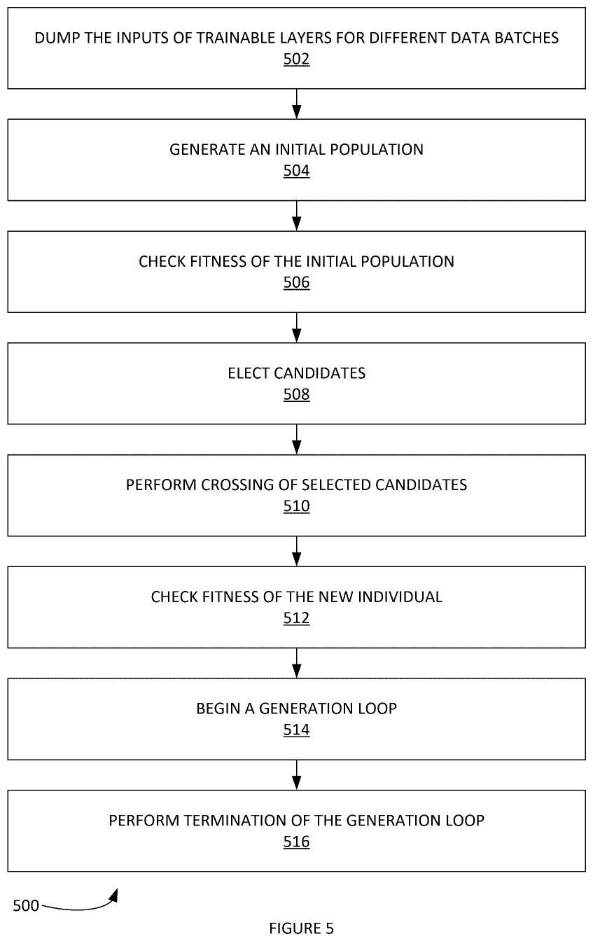

FIG. 5 illustrates an example process 500 for implementing a genetic algorithm-based adaptive batch selection for Hessian Quantization in neural networks, according to some embodiments. In step 502, process 500 can dump the inputs of trainable layers for different data batches. It is noted that there are Trainable layers (e.g. Dense Layers, Convolution Layers, etc.) and Non-Trainable Layers (e.g. Pooling Layers, Concat Layers, etc.) in a neural network. The trainable layers have trainable parameters (e.g. Weights, Biases, etc.). In any quantization method those trainable parameter matrices are quantized. In one example, only the inputs of Trainable layers are required to be dumped for the quantization process. The process of applying a genetic algorithm to layer-wise batch selection begins by writing (e.g. dumping) the inputs of each Trainable layer in the model from different data batches to the storage. Process 500 can use these dumped layer inputs for the hessian quantization of the corresponding layers.

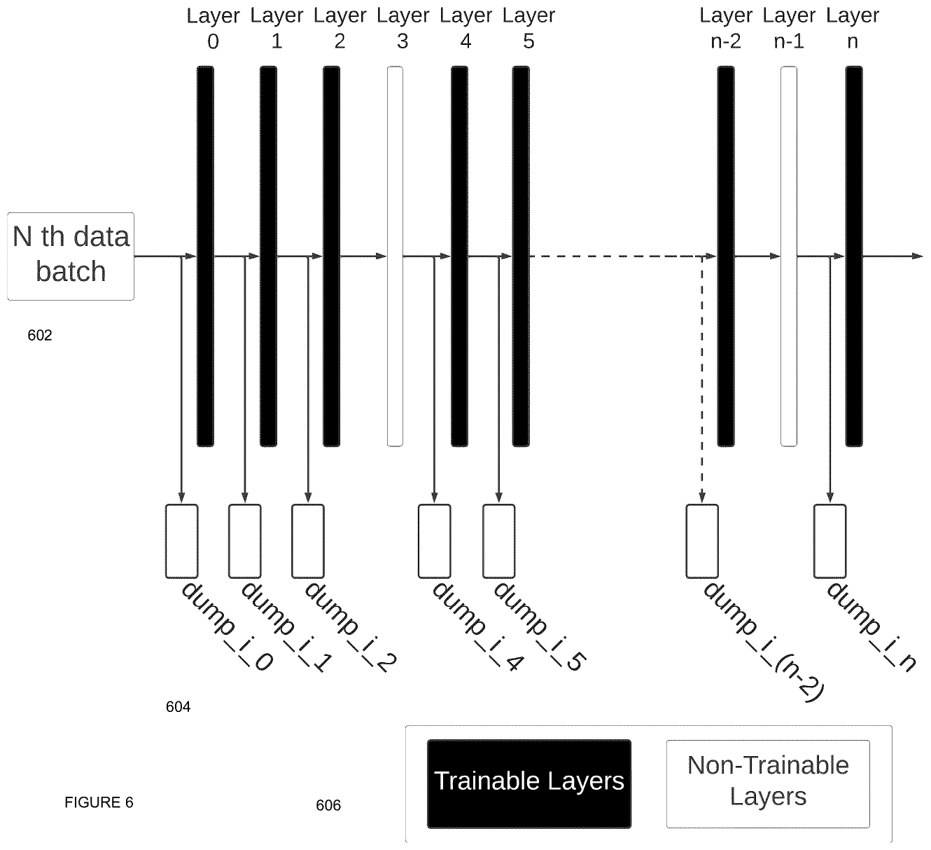

FIG. 6 illustrates an example schematic 600 for Dumping inputs of Trainable Layers, according to some embodiments. Block 602 shows the N′th input data batch is given as input to the model. Block 604 shows the input dump of each NN layer with trainable weights. Block 606 shows a Colormap.

Returning to process 500, in step 504, process 500 can generate an initial population. An initial population of batch combinations is generated, representing various strategies for batch selection. This step lays the groundwork for identifying the most effective combinations through the genetic algorithm.

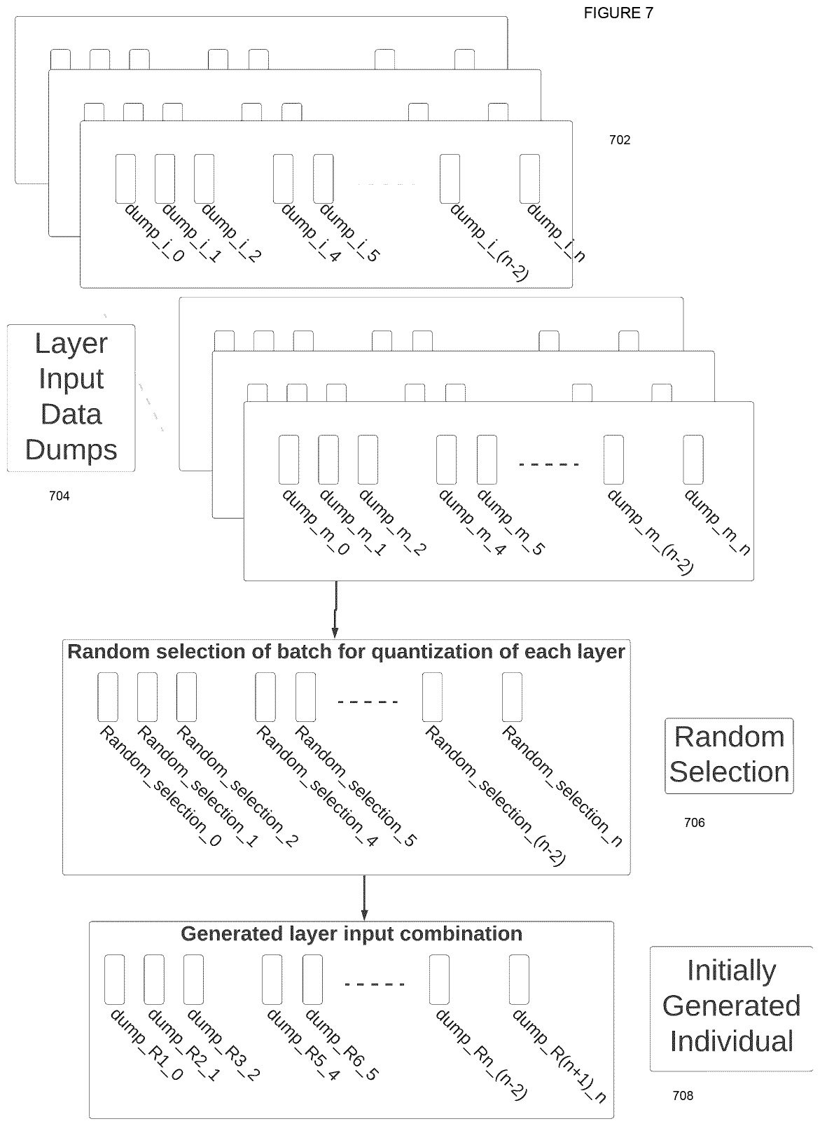

FIG. 7 an example process 700 for generating initial candidates, according to some embodiments. The Colormap 702 related to the Input data dumps of each NN layer of the model for each data batch as shown in block 704. Block 706 shows a set of input data batches. Block 708 shows randomly select an input dump for each layer from the set in 704. Block 706 shows the generating of a new layer input dump combination using process.

Returning to process 500, in step 506, process 500 can check fitness of the initial population. Each batch combination in the initial population is evaluated for its effectiveness in optimizing the Hessian quantization process. This evaluation can be based on a fitness function designed to measure improvements in model performance and accuracy.

In step 508, process 500 can select candidates. From the population, candidate batch combinations demonstrating the highest fitness scores can be selected for reproduction. This selection prioritize the combinations that show potential for significant improvements in quantization efficiency.

In step 510, process 500 can perform crossing of selected candidates. The selected candidates undergo crossover operations, where genetic material (e.g. strategies for batch selection) is crossed-over to produce offspring. This step encourages the exploration of new batch combination strategies.

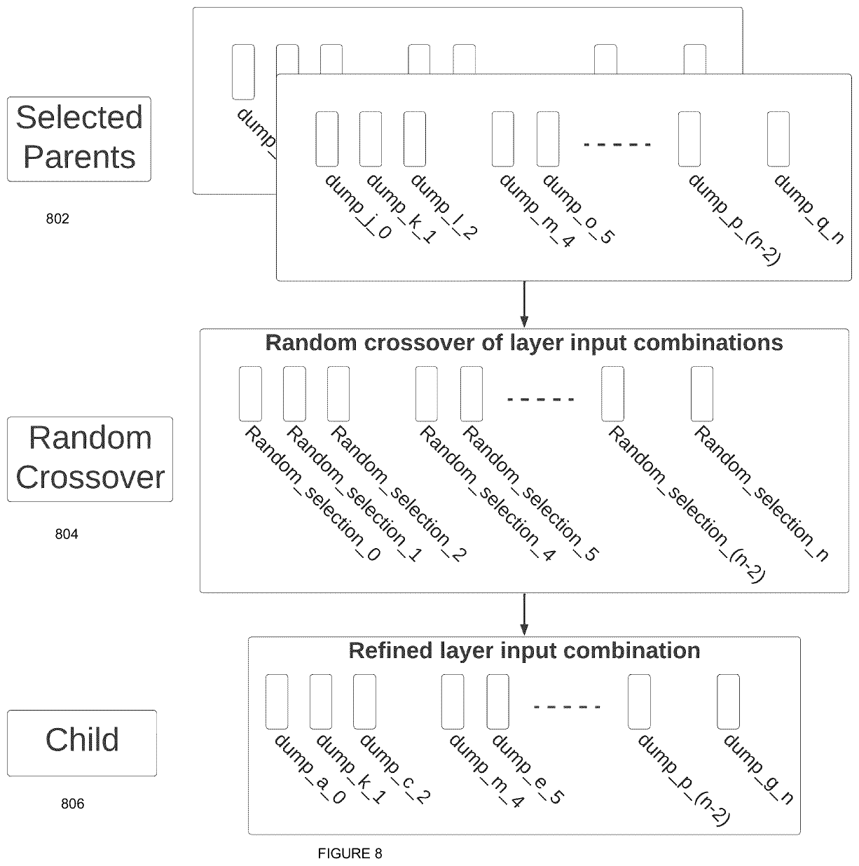

FIG. 8 an example process 800 for implementing a crossover of the selected candidates, according to some embodiments. Block 802 shows the input data dumps of each NN layer of the model assigned to the parents selected in diagram 200, step 212. Block 804 shows random selection of an input dump for each layer from the layer input dump combination of each parent. Block 806 shows the generation a new layer input dump combination using process 804 and assign it to a new individual (e.g. a child).

In step 512, process 500 can check fitness of the new individual. The fitness of each new batch combination (offspring) is assessed to determine its effectiveness in enhancing the Hessian quantization process. The new offspring is incorporated into the population.

In step 514, process 500 can begin a generation loop. The generation loop begins after the fitness of all candidates are evaluated. Then the cycle of generating populations, evaluating fitness of newly generated individuals, selecting candidates, crossing, and mutation is repeated. This iterative process is the core of the genetic algorithm, allowing for continuous refinement and optimization of batch selections.

In step 516, process 500 can perform termination of the generation loop. The optimization loop concludes once a predefined termination criterion is met. This criterion may be established as a certain number of generations or the indication that further iterations are unlikely to yield significant improvements. The optimal batch selection strategy identified at this stage is then applied to the neural network for Hessian quantization.

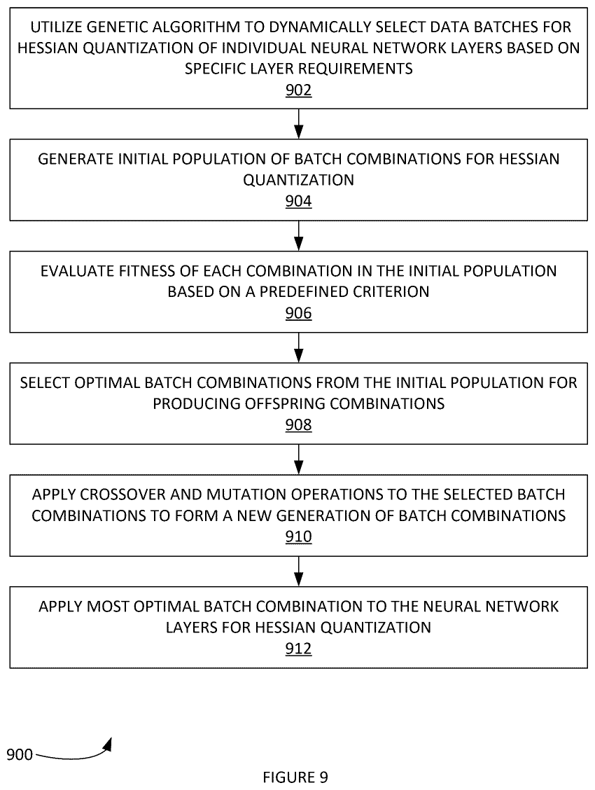

FIG. 9 illustrates an example process 900 for optimizing neural network layers, according to some embodiments. In step 902, process 900 utilizes a Genetic Algorithm to dynamically select data batches for Hessian quantization of individual neural network layers based on specific layer requirements. In step 904, process 900 generates an initial population of batch combinations for Hessian quantization.

In step 906, process 900 evaluates the fitness of each combination in the initial population based on a predefined criterion. In step 908, process 900 selects optimal batch combinations from the initial population for producing offspring combinations. In step 910, process 900 applies crossover and mutation operations to the selected batch combinations to form a new generation of batch combinations.

It is noted that process 900 can repeat steps 906 through 910 for a predefined number of iterations or until a termination criterion is met. In step 912, process 900 applies the most optimal batch combination to the neural network layers for Hessian quantization.

The genetic algorithm dynamically adapts batch selection strategies based on varying data dependencies and sensitivities to quantization levels across different layers. Process 900 can also perform eigenvalue analysis on the Hessian matrix of each layer to determine appropriate quantization levels. The quantization levels can be applied to layer weights, mapping continuous floating-point values to discrete levels.

It is noted that process 900 can be performed by a neural network optimization system. The neural network optimization system includes a processor, and a memory coupled to the processor. The memory can store instructions that, when executed by the processor, cause the system to perform the steps of any of process 900 (and/or processes 100-500 as well). The genetic algorithm improves overall model performance by ensuring that each neural network layer receives the most suitable batch for quantization, thereby maximizing the efficiency of the neural network optimization process.

Example embodiments provide that the integration of Genetic Algorithms for adaptive batch selection in the context of Hessian quantization enhances the efficiency and performance of neural network optimization. Traditional approaches, which typically employ uniform batch selection for Hessian quantization, fall short in addressing the unique characteristics and sensitivities of individual layers within neural networks. Processes provided herein leverage the principles of natural selection and genetics, offering a dynamic and tailored approach to batch selection, thereby optimizing the quantization process across different layers. This innovation surpasses traditional limitations, ushering in a new standard of precision in neural network quantization.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A computerized method of a genetic algorithm-based adaptive batch selection for hessian quantization in neural networks comprising:
with at least one computer processer, computing a Hessian Matrix;
performing an Eigenvalue Analysis on the Hessian matrix to generate a Hessian matrix eigenvalue that provides information about the curvature of the loss surface;
determining a quantization level based on the Hessian matrix eigenvalue;
using the quantization Level to set an appropriate quantization level for a layer weights of a neural network; and
applying the quantization level to the layer weights of the neural network. This involves mapping the continuous floating-point values of the weights to discrete levels based on the determined quantization intervals.

2. The method of claim 1, wherein Hessian matrix provides information about a curvature of a loss surface with respect to a plurality of model parameters of at least one neural network implemented in a computing system.

3. The computerized method of claim 2, wherein the computing of the Hessian matrix comprises:
calculating second-order partial derivatives of a loss function with respect to each parameter.

4. The computerized method of claim 3, wherein the Hessian matrix is computed with an analytical algorithm.

5. The computerized method of claim 3, wherein the Hessian matrix is approximated numerical algorithm.

6. The computerized method of claim 2, wherein a higher eigenvalue indicates a region of high curvature.

7. The computerized method of claim 6, wherein a lower eigenvalue indicates a region of low curvature.

8. The computerized method of claim 7, wherein the regions of high curvature is indicated.

9. The computerized method of claim 8 further comprising:
setting a finer quantization level for the layer weight of the neural network to preserve a model accuracy.

10. The computerized method of claim 7, wherein a region of low curvature is detected.

11. The computerized method of claim 10 further comprising:
setting a coarser quantization level for the layer weight of the neural network to preserve a model accuracy.

12. The computerized method of claim 7, wherein the step of applying the quantization level to the layer weights of the neural network further comprises:
mapping a continuous floating-point value of a plurality of weights to a plurality of discrete levels based on the quantization intervals.

13. The computerized method of claim 12 further comprising:
using a genetic algorithm to generate an optimal batch combination out of a solution space.

14. The computerized method of claim 13 further comprising:
implementing an application of genetic algorithm specifically designed for a batch selection in the context of the Hessian Quantization.

15. The computerized method of claim 14, wherein the optimization of the batch selection based on a requirements of each layer of the neural network.

16. The computerized method of claim 15 further comprising:
enabling the genetic algorithm to dynamically adapt and optimize the batch selection.

17. The computerized method of claim 16 further comprising:
providing a plurality of interconnections between the genetic algorithm and the Hessian quantization process.

18. The computerized method of claim 17, wherein the genetic algorithm interacts with the quantization process to determine a most optimal batch combination for each layer of the neural network.
